(19) United States
(12) Patent Application Publication
(10) Pub. No.: US 2025/0188580 A1
(43) Pub. Date: Jun. 12, 2025

(54) IRON-BASED ALLOY MATERIAL, METAL STRUCTURE AND METHOD OF REPAIRING STEEL SURFACE

(71) Applicant: Industrial Technology Research Institute, Hsinchu (TW)

(72) Inventors: Hsuan-Kuang Chen, Keelung City (TW); Chun-Wei Yueh, Chiayi City (TW); Tai-Sheng Chen, Hsinchu County (TW); Wei-Tien Hsiao, Hsinchu County (TW)

(73) Assignee: Industrial Technology Research Institute, Hsinchu (TW)

(21) Appl. No.: 18/926,214

(22) Filed: Oct. 24, 2024

(30) Foreign Application Priority Data
Dec. 8, 2023 (TW) 112147776

(51) Int. Cl. C22C 38/46; B32B 15/01; B33Y 70/00; C22C 38/02; C22C 38/04

(52) U.S. Cl. CPC C22C 38/46; B32B 15/011; C22C 38/02; C22C 38/04; B33Y 70/00

(57) ABSTRACT

An iron-based alloy material includes 7 wt % to 12 wt % of chromium, 3.0 wt % to 9.0 wt % of nickel, a total amount of 8.5 wt % to 14 wt % of manganese, vanadium, silicon, and carbon, 70 wt % to 80 wt % of iron, and unavoidable impurities. A metal structure includes a base material, an interface layer, and a hard layer. The interface layer is disposed on the base material. The hard layer is disposed on the interface layer and includes the iron-based alloy material. A method of repairing steel surface includes the following steps: providing steel; forming an interface layer on a surface of the steel; and forming a hard layer on the interface layer.

### CROSS-REFERENCE TO RELATED APPLICATION

This application claims the priority benefit of Taiwan application serial no. 112147776, filed on Dec. 8, 2023. The entirety of the above-mentioned patent application is hereby incorporated by reference herein and made a part of this specification.

### TECHNICAL FIELD

This disclosure relates to an iron-based alloy material, a metal structure, and a method of repairing steel surface.

### BACKGROUND

In the steel manufacturing industry, heat treatment and other methods are generally used to form a hard layer (e.g., tempered martensite structure) on the steel to increase the hardness and at the same time improve the wear resistance of the surface to cope with the extreme operating conditions and wear and tear from long-term use.

However, when a hard layer formed by heat treatment is worn out, it is difficult to repair it by conventional electric welding or argon welding, and even if the hard layer is repaired by homogenized heat treatment and then welded, the hard layer after repair is likely to be insufficient in thickness and hardness. As a result, the metal structure with hard layer that has been worn away is usually subject to obsolescence.

### SUMMARY

The disclosure provides an iron-based alloy material, a metal structure, and a method of repairing steel surface.

In some embodiments of the disclosure, the iron-based alloy material of the disclosure includes 7 wt % to 12 wt % of chromium, 3.0 wt % to 9.0 wt % of nickel, a total amount of 8.5 wt % to 14 wt % of manganese, vanadium, silicon, and carbon, 70 wt % to 80 wt % of iron, and unavoidable impurities.

In some embodiments of the disclosure, the metal structure of the disclosure includes a base material, an interface layer, and a hard layer. The interface layer is disposed on the base material. The hard layer is disposed on the interface layer and includes the iron-based alloy material. The interface layer is disposed between the hard layer and base material.

In some embodiments of the disclosure, the method of repairing steel surface of the disclosure includes the following. Steel is provided. An interface layer is formed on a surface of the steel. A hard layer is formed on the interface layer.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic cross-sectional view of a metal structure according to an embodiment of the disclosure.

FIG. 2 to FIG. 4 show weight changes and heat flow changes of comparative example 1, embodiment 3 and a chromium-molybdenum steel base material in a heating environment, respectively.

FIG. 5 shows hardness of comparative example 1 and embodiment 3 at different temperatures.

FIG. 6 shows Young's modulus of comparative example 1 and embodiment 3 at different temperatures.

### DESCRIPTION OF THE EMBODIMENTS

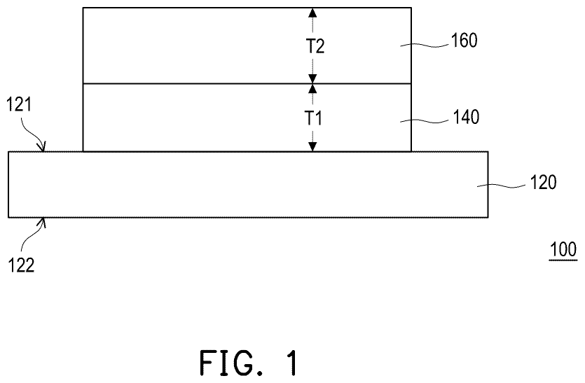

FIG. 1 is a schematic cross-sectional view of a metal structure according to an embodiment of the disclosure. Referring to FIG. 1, a metal structure 100 of this embodiment includes a base material 120, an interface layer 140, and a hard layer 160.

Specifically, the base material 120 has a surface 121 and a surface 122 opposite to each other. In this embodiment, the base material 120 may be steel. For example, the base material 120 may be, but is not limited to, chromium-molybdenum steel, stainless steel, a steel rolling roller, a mechanical transmission shaft, and a flange surface of pipeline, or other suitable steel.

The interface layer 140 is disposed on the surface 121 of the base material 120, and the interface layer 140 can be disposed between the hard layer 160 and the base material 120. The interface layer 140 may be used to improve the adhesion or adhesion strength between the hard layer 160 and the base material 120 to effectively resist the action of stress and reduce the probability of peeling of the hard layer 160 under the action of thermal stress.

The interface layer 140 has a thickness T1. In this embodiment, the thickness T1 of the interface layer 140 may be, for example, 0.5 mm to 1 mm, 0.5 mm to 0.8 mm, or 0.5 mm to 0.6 mm, but is not limited thereto. In this embodiment, the interface layer 140 may be, for example, an iron-chromium-nickel alloy (FeCrNi) with high toughness and easy welding. For example, the material of the interface layer 140 may include, but is not limited to, 22 wt % to 24 wt % of chromium (Cr), 12 wt % to 14 wt % of nickel (Ni), the remainder of iron (Fe), and unavoidable impurities.

The hard layer 160 is disposed on the interface layer 140, and the hard layer 160 and the base material 120 are located on opposite sides of the interface layer 140 respectively. The hard layer 160 has a thickness T2. In this embodiment, the thickness T2 of the hard layer 160 may be, for example, 2 mm to 7 mm to increase the service life of the metal structure, but is not limited thereto. When the thickness of the hard layer is less than 2 mm, the hard layer would be worn out more quickly, thus reducing the service life of the hard layer. When the thickness of the hard layer is greater than 7 mm, a longer processing (heating) time would be required, which increases the probability of cracking or peeling of the hard layer due to the accumulation of stress and heat.

In one embodiment, the Vickers hardness of the hard layer 160 may be, for example, 500 HV to 750 HV to increase the service life, but is not limited thereto. When the Vickers hardness of the hard layer is less than 500 HV, it would accelerate that the hard layer is worn out, thus reducing the service life. When the Vickers hardness of the hard layer is greater than 750 HV, the material of the hard layer would become hard and brittle, which increases the probability of cracking or breaking of the hard layer under the action of thermal stress.

In one embodiment, the material of the hard layer 160 may be, for example, an iron-based alloy material with wear resistance and high hardness. The iron-based alloy material may include 7 wt % to 12 wt % of chromium, 3.0 wt % to 9.0 wt % of nickel, a total amount of 8.5 wt % to 14 wt % of manganese (Mn), vanadium (V), silicon (Si) and carbon (C), 70 wt % to 80 wt % of iron, and unavoidable impurities, based on a total weight of the iron-based alloy material.

In one embodiment, in a total amount of 8.5 wt % to 14 wt % of manganese, vanadium, silicon, and carbon, the content of manganese may be, for example, 0.3 wt % to 1.5 wt %, the content of vanadium may be, for example, 1.5 wt % to 5.0 wt %, the content of silicon may be, for example, 0.3 wt % to 1.8 wt %, and the content of carbon may be, for example, 5.0 wt % to 7.5 wt %, but is not limited thereto. When the content of manganese exceeds 1.5 wt % and/or the content of Si exceeds 1.8 wt %, the toughness of the material of the hard layer would decrease and become hard and brittle, and even affect the capability of cladding (weldability) of the material. When the content of vanadium exceeds 5.0 wt %, the ductility of the hard layer would be reduced and the hard layer would be susceptible to cracking.

In this embodiment, a manufacturing method of the metal structure 100 may include but is not limited to the following steps. First, the base material 120 is provided, in which the base material 120 may be steel. Next, the interface layer 140 is formed on the surface 121 of the base material 120. Next, the hard layer 160 is formed on the surface of the interface layer 140 facing away from the base material 120. The method of forming the hard layer 160 on the interface layer 140 may be, for example, laser metal deposition (LMD), laser cladding, or laser additive manufacturing, but is not limited thereto. When the steel is a worn or discarded steel roller, the manufacturing method of the metal structure 100 can be applied as a method of repairing steel surface, but is not limited thereto.

Compared with the general use of heat treatment to form a hard layer (e.g., tempered martensite structure), which is difficult to repair after wear and must be obsolescence. In this embodiment a hard layer is formed through laser metal deposition, laser cladding, or laser additive manufacturing, that may be partially worn and may be repaired to achieve the effect of reuse, reduce carbon emissions, and reduce costs.

The metal structure 100 of the disclosure can be used in the steel manufacturing industry, for example, for the manufacture or wear repair of rolling rollers during high-temperature shaping processing of steel sections, steel bars, and steel plates, but is not limited thereto.

In the following, the efficacy of the iron-based alloy material, the metal structure, and the method for repairing steel surface of the disclosure are described in detail by means of experiments. However, the following experiments are not intended to limit the disclosure.

### <Preparation of Metal Structure of Embodiment 1 to Embodiment 5 and Comparative Example 1 to Comparative Example 2>

### Embodiment 1

First, chromium-molybdenum steel was provided as a base material. Next, laser metal deposition was used to clad the iron-chromium-nickel alloy as an interface layer on the surface of the chromium-molybdenum steel, in which a thickness of the iron-chromium-nickel alloy is 1 mm. Next, laser metal deposition was used to clad an iron-based alloy material as a hard layer on the iron-chromium-nickel alloy to obtain the metal structure of embodiment 1. The composition and content of the iron-based alloy material of the hard layer in the metal structure of embodiment 1 are recorded in Table 1 below.

### Embodiment 2

The metal structure of embodiment 2 was prepared by the same steps as embodiment 1, with the difference that the composition content of the iron-based alloy material of the hard layer in the metal structure of embodiment 2 is as shown in Table 1.

### Embodiment 3

The metal structure of embodiment 3 was prepared by the same steps as embodiment 1, with the difference that the composition content of the iron-based alloy material of the hard layer in the metal structure of embodiment 3 is as shown in Table 1.

### Embodiment 4

The metal structure of embodiment 4 was prepared by the same steps as embodiment 1, with the difference that the base material of embodiment 4 is stainless steel and the composition content of the iron-based alloy material of the hard layer in the metal structure of embodiment 4 is as shown in Table 1.

### Embodiment 5

The metal structure of embodiment 5 was prepared by the same steps as embodiment 1, with the difference that the base material of embodiment 5 is stainless steel and the composition content of the iron-based alloy material of the hard layer in the metal structure of embodiment 5 is as shown in Table 1.

### Comparative Example 1

The metal structure of Comparative example 1 was prepared by the same steps as embodiment 1, with the difference that comparative example 1 is not provided with an interface layer (that is, the base material of comparative example 1 directly contacts the hard layer), and comparative example 1 uses a high carbon steel as the hard layer. The composition and content of the high carbon steel in comparative example 1 are recorded in Table 1 below.

### Comparative Example 2

The metal structure of comparative example 2 was prepared by the similar steps as embodiment 1, with the difference that the component content of the iron-based alloy material used in comparative example 2 is as shown in Table 1. In addition, comparative example 2 is not provided with an interface layer, and the base material of comparative example 2 directly contacts the hard layer.

TABLE 1

| | hard layer | | | | | | |
|---|---|---|---|---|---|---|---|
| | Embodiment | Embodiment | Embodiment | Embodiment | Embodiment | Comparative | Comparative |
| | 1 | 2 | 3 | 4 | 5 | example 1 | example 2 |
| Fe (%) | 70.88 | 75.19 | 77.52 | 79.38 | 74.74 | 80.75 | 73.75 |
| Cr (%) | 11.47 | 8.69 | 8.26 | 7.14 | 7.04 | 6.56 | 6.7 |
| Ni (%) | 8.72 | 6.48 | 4.2 | 3.6 | 4.86 | 0 | 3.36 |
| Mn(%) | 0.96 | 0.32 | 0.73 | 1.11 | 0.69 | 0 | 1.37 |
| V (%) | 1.85 | 2.65 | 2.31 | 3.02 | 4.32 | 4.07 | 5.19 |
| Si (%) | 0.94 | 1.26 | 1.73 | 0.37 | 1.31 | 0.99 | 3 |
| C (%) | 5.18 | 5.41 | 5.25 | 5.38 | 7.04 | 7.63 | 6.63 |

### <Characteristic Analysis of Metal Structure>

The metal structures of embodiment 1 to embodiment 5 and comparative example 1 to comparative example 2 were subjected to the following characteristic analyses: observation of the adhesion of the hard layer, observation of the surface smoothness of the hard layer, measurement of the thickness of the hard layer, measurement of the Vickers hardness of the hard layer, measurement of stability at high temperature, and measurement of hardness and rigidity at high temperature. The results of these analyses are shown in Table 2.

Observation of the adhesion of the hard layer: the observation, using an optical microscope, of the bonding condition between the hard layer and the base material in the metal structure, particularly at the edges of the metal structure, to determine whether the bonding is satisfactory (i.e., the hard layer exhibits good adhesion or high bonding strength) or whether there is delamination (i.e., the hard layer exhibits poor adhesion or low bonding strength).

Observation of the surface smoothness of the hard layer: the observation, using an optical microscope, of whether the surface of the hard layer in the metal structure is smooth (i.e., the hard layer exhibits good surface smoothness) or contains cracks (i.e., the hard layer exhibits poor surface smoothness).

Measurement of the thickness of the hard layer: the measurement, using an optical microscope, of the thickness of the hard layer in the metal structure.

Measurement of the Vickers hardness of the hard layer: the measurement, using an optical microscope (Mitutoyo HM-100), of the hardness of the hard layer in the metal structure. The measurement was carried out in accordance with the measurement standards of ISO 6507-1 and JIS Z 2244. The instrument was calibrated in accordance with ISO 6507-2 and JIS B 7725.

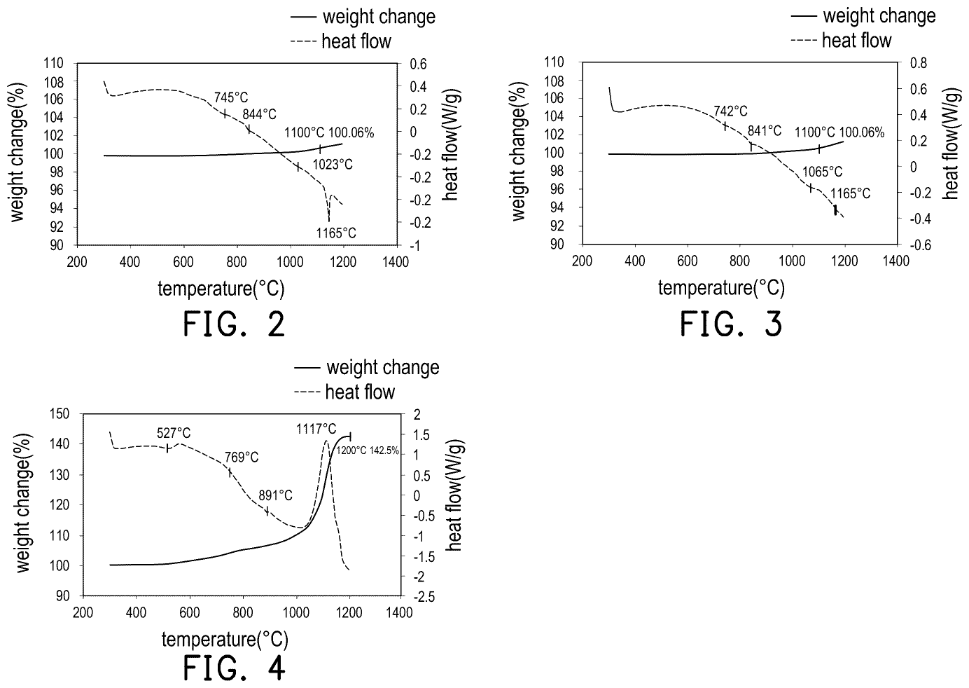

Measurement of stability at high temperature: the measurement, in an environment of gradually increasing temperature (from approximately 300° C. to approximately 1200° C.), of the weight change of the metal structure (calculation of the change (%) in weight after heating based on the initial weight at the starting temperature) and the change in heat flow (measured in W/g). FIG. 2 to FIG. 4 are used to illustrate changes in the weight and changes in heat flow of comparative example 1, example 3, and the chromium-molybdenum steel base material in a heating environment.

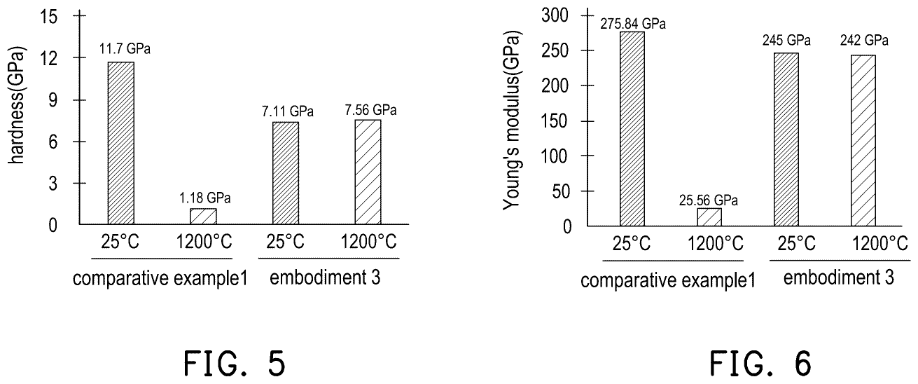

Measurement of hardness and rigidity at high temperature: the hardness (GPa) and Young's modulus (GPa) of the metal structure were analyzed by Nanoindentation. Using nanoindentation technology (Nanoindentation) to analyze the hardness (GPa) and Young's modulus (Young's modulus) of the metal structure at room temperature of about 25° C. and high temperature environment of about 1200° C. (GPa) remained roughly unchanged or changed significantly, the maximum depth of indentation is 1 micron. FIG. 5 is used to illustrate hardness of comparative example 1 and embodiment 3 at different temperatures, and FIG. 6 is used to illustrate Young's modulus of comparative example 1 and embodiment 3 at different temperatures.

TABLE 2

| | Embodiment | Embodiment | Embodiment | Embodiment | Embodiment | Comparative | Comparative |
|---|---|---|---|---|---|---|---|
| | 1 | 2 | 3 | 4 | 5 | example 1 | example 2 |
| adhesion | satisfactory | satisfactory | satisfactory | satisfactory | satisfactory | poor | poor |
| surface | satisfactory | satisfactory | satisfactory | satisfactory | satisfactory | poor | acceptable |
| smoothness | | | | | | | |
| thickness (mm) | 2 | 2 | 3 | 4 | 7 | 2 | 2 |
| Vickers | 530 | 590 | 650 | 670 | 750 | 850 | 700 |
| hardness (HV) | | | | | | | |
| stability at high | satisfactory | satisfactory | satisfactory | satisfactory | satisfactory | poor | satisfactory |
| temperature | | | | | | | |
| hardness at high | unchanged | unchanged | unchanged | unchanged | unchanged | decreased | unchanged |
| temperature | | | | | | | |
| rigidity at high | unchanged | unchanged | unchanged | unchanged | unchanged | decreased | unchanged |
| temperature | | | | | | | |

According to the results in Table 2, it can be seen that compared with comparative examples 1 and 2 without an interface layer, embodiments 1 to 5 with an interface layer have better adhesion and make the hard layer less likely to peel off.

According to the results in Table 2, it can be seen that compared with comparative example 1 using high carbon steel as the hard layer, embodiments 1 to 5 using iron-based alloy material as the hard layer have better surface smoothness. Specifically, hardness is a measure of the ability of material to resist permanent deformation (indentations, scratches, bends, etc.). Generally, the higher the hardness value, the better the wear resistance of the material, but it may be relatively harder and brittle. As shown in Table 2, although high carbon steel has higher Vickers hardness, it is also easy to have cracks even when the thickness of the high carbon steel is not large (about 2 mm) due to the hard and brittle nature of the high carbon steel, resulting in poor surface smoothness. On the contrary, due to the addition of trace elements (such as nickel and manganese), the iron-based alloy materials of embodiments 1 to 5 can increase toughness and improve the problem of easy brittleness, and thus have better surface smoothness.

According to the results in Table 2, it can be seen that compared with comparative example 1 using high carbon steel as the hard layer, embodiments 1 to 5 using iron-based alloy material as the hard layer have better stability at high temperatures. In detail, in FIG. 2, although the weight of comparative example 1 does not change significantly as the temperature increases, and the heat flow gradually decreases as the temperature increases, a melting point can be indicated because the heat flow has a significant downward peak at 1165° C., which in turn indicates that comparative example 1 is less stable at high temperatures. In FIG. 3, the weight of embodiment 3 does not change significantly as the temperature increases, the heat flow gradually decreases as the temperature increases, and the heat flow does not have an obvious peak when the temperature increases, thus indicating that there is no melting point and no serious oxidation, which further indicates that embodiment 3 is more stable at high temperatures. In FIG. 4, the weight of the chromium-molybdenum steel base material changes significantly as the temperature increases, and the heat flow shows an obvious upward peak between about 1000 to 1200° C., with a peak at 1117° C., which can indicate that there is intense oxidation, which in turn indicates that the chromium-molybdenum steel base material is less stable at high temperatures.

According to the results in Table 2, compared with comparative example 1 using high carbon steel as the hard layer, the hardness and rigidity of the iron-based alloy material of embodiments 1 to 5 can be maintained at high temperatures without significant changes. Specifically, in FIG. 5, the hardness of comparative example 1 at high temperature is significantly smaller than the hardness at low temperature, indicating that comparative example 1 has a problem of reduced hardness at high temperature; however, the hardness of embodiment 3 at high temperature can be substantially similar to the hardness at low temperature, indicating that the design of embodiment 3 can be used to improve the problem of easy hardness decrease caused by high temperature. In FIG. 6, the Young's modulus of comparative example 1 at high temperature is significantly smaller than the Young's modulus at low temperature, indicating that comparative example 1 has a problem of reduced rigidity at high temperature; however, the Young's modulus of embodiment 3 at high temperature can be substantially similar to the Young's modulus at low temperature, indicating that the design of embodiment 3 can be used to improve the problem of easy decrease in rigidity caused by high temperature.

According to the results in Table 1 and Table 2, although comparative example 2 uses iron-based alloy material as the hard layer, the surface flatness of comparative example 2 is still worse than that of embodiments 1 to 5. In detail, since the content of Mn and/or Si in comparative example 2 is significantly higher than that in embodiments 1 to 5, the material toughness of the hard layer in comparative example 2 decreases and becomes hard and brittle, and even affects the capability of cladding (weldability) of the material. In addition, since the content of V in comparative example 2 is significantly higher than that in embodiments 1 to 5, the ductility of the hard layer in comparative example 2 is reduced and it is easy to crack. In addition, since comparative example 2 does not have an interface layer and the base material is very hard and brittle after heat treatment, cracks may extend upward from the base material to the surface of the hard layer.

According to the results in Table 2, it can be seen that embodiments 1 to 5 may simultaneously have the properties of high hardness (i.e., a Vickers hardness of greater than 500 HV), wear resistance (i.e., good surface smoothness, a thickness of greater than or equal to 2 mm, and a Vickers hardness of greater than 500 HV), and high-temperature resistance (i.e., good stability at high temperatures, no change in hardness at high temperatures, and no change in rigidity at high temperatures).

To sum up, in the iron-based alloy material, metal structure, and the method of repairing steel surface according to an embodiment of the disclosure, since the iron-based alloy material may include 7 wt % to 12 wt % of chromium, 3.0 wt % to 9.0 wt % of nickel, and a total amount of 8.5 wt % to 14 wt % of manganese, vanadium, silicon, and carbon, the metal structure containing iron-based alloy material can be characterized by having high hardness, wear resistance, and high temperature resistance at the same time, which reduces the chance of cracking or peeling, increases service life, and improves the problem of decreasing hardness and rigidity caused by high temperature.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An iron-based alloy material, comprising:
7 wt % to 12 wt % of chromium;
3.0 wt % to 9.0 wt % of nickel;
a total amount of 8.5 wt % to 14 wt % of manganese, vanadium, silicon, and carbon;
70 wt % to 80 wt % of iron; and
unavoidable impurities.

2. The iron-based alloy material according to claim 1, wherein content of the manganese is 0.3 wt % to 1.5 wt %, content of the vanadium is 1.5 wt % to 5.0 wt %, content of the silicon is 0.3 wt % to 1.8 wt %, and content of the carbon is 5.0 wt % to 7.5 wt %.

3. A metal structure, comprising:
a base material;
an interface layer, disposed on the base material; and
a hard layer, disposed on the interface layer, comprising the iron-based alloy material according to claim 1,
wherein the interface layer is disposed between the hard layer and the base material.

4. The metal structure according to claim 3, wherein the base material is steel.

5. The metal structure according to claim 3, wherein a material of the interface layer comprises:
22 wt % to 24 wt % of chromium;
12 wt % to 14 wt % of nickel; and
a remainder of iron and unavoidable impurities.

6. The metal structure according to claim 3, wherein the interface layer has a thickness of 0.5 mm to 1 mm.

7. The metal structure according to claim 3, wherein the hard layer has a thickness of 2 mm to 7 mm.

8. The metal structure according to claim 3, wherein Vickers hardness of the hard layer is 500 HV to 750 HV.

9. A method of repairing steel surface, comprising:
providing steel;
forming an interface layer on a surface of the steel; and
forming a hard layer on the interface layer, wherein the hard layer comprises the iron-based alloy material according to claim 1.

10. The method according to claim 9, wherein forming the hard layer on the interface layer is laser metal deposition, laser cladding, or laser additive manufacturing.

11. The method according to claim 9, wherein the steel is a worn or discarded steel roller.
